(19) United States
(12) Patent Application Publication
(10) Pub. No.: US 2021/0109763 A1
(43) Pub. Date: Apr. 15, 2021

(54) METHODS, APPARATUSES AND SYSTEMS FOR DEPLOYING CONNECTED DEVICES FOR CONTROL SYSTEMS

(71) Applicant: Honeywell International Inc., Morris Plains, NJ (US)

(72) Inventor: Sreejith NAARAKATHIL, Bangalore (IN)

(21) Appl. No.: 16/600,098

(22) Filed: Oct. 11, 2019

(51) Int. Cl. G06F 9/4401; G06F 9/48; G05B 19/04; H04W 84/18; H04W 4/029

(52) U.S. Cl. CPC G06F 9/4411; G06F 9/485; H04W 4/029; H04W 84/18; G05B 19/04

(57) ABSTRACT

Methods, apparatuses, and systems for deploying connected devices for control systems are provided. An example method may include receiving location data associated with at least one Type-1 device and at least one Type-2 device, generating at least one Type-1 secure-ware for the at least one Type-1 device and at least one Type-2 secure-ware for the at least one Type-2 device based at least in part on the location data, transmitting the at least one Type-1 secure-ware and the at least one Type-2 secure-ware to the at least one Type-1 device, and causing the at least one Type-1 device to execute the at least one Type-1 secure-ware. Example methods, apparatuses, and systems may be implemented in, including but is not limited to, cyber security and/or converged physical and cyber security risk analysis in control systems and/or intrusion detection systems.

### FIELD OF THE INVENTION

The present disclosure relates generally to methods, apparatuses, and systems associated with connected devices, and more particularly, to methods, apparatuses, and systems for deploying connected devices for control systems.

### BACKGROUND

A “control system” refers to a set of mechanical and/or electronic devices that may manage other devices and/or systems. For example, a commercial control system may include hundreds of sensors connected to a control panel.

Many systems and methods do not overcome technical challenges and difficulties associated with control systems. For example, many systems and methods may implement a hardware intensive deployment model, which may require multiple variants of hardware for similar products sold in various regions/countries. As another example, many systems and methods require maintaining a vast number of firmware sources to support a variety of sensors and panels.

### BRIEF SUMMARY

In accordance with various examples, an apparatus is provided. The apparatus may comprise a first processor and a first non-transitory memory comprising program code. The first non-transitory memory and the program code may be configured to, with the first processor, cause the apparatus to at least: receive location data associated with at least one Type-1 device and at least one Type-2 device; based at least in part on the location data, generate at least one Type-1 secure-ware for the at least one Type-1 device and at least one Type-2 secure-ware for the at least one Type-2 device; transmit the at least one Type-1 secure-ware and the at least one Type-2 secure-ware to the at least one Type-1 device; and cause the at least one Type-1 device to execute the at least one Type-1 secure-ware. In some examples, the at least one Type-1 secure-ware may be configured to cause the at least one Type-1 device to transmit the at least one Type-2 secure-ware to the at least one Type-2 device.

In some examples, the at least one Type-1 device may comprise at least one second processor and at least one second non-transitory memory. In some examples, the at least one Type-1 device may comprise at least one of a camera element or a microphone element. In some examples, the at least one Type-1 device may comprise a sensor-independent interface. The sensor-independent interface may be configured to electronically couple the at least one Type-1 device to the at least one Type-2 device.

In some examples, the at least one Type-1 secure-ware may comprise at least one life cycle indicator. The first non-transitory memory and the program code may be configured to, with the first processor, cause the apparatus to further cause the at least one Type-1 device to exit the at least one Type-1 secure-ware based on the at least one life cycle indicator.

In some examples, the at least one Type-2 device may comprise at least one sensor-dependent interface. The at least one sensor-dependent interface may be configured to electronically couple the at least one Type-2 device to at least one sensing element.

In some examples, the at least one Type-2 secure-ware may comprise at least one software driver for the at least one sensing element. In some examples, the at least one Type-2 secure-ware may comprise at least one life cycle indicator. The first non-transitory memory and the program code may be configured to, with the first processor, cause the apparatus to further cause the at least one Type-2 device to exit the at least one Type-2 secure-ware based on the at least one life cycle indicator.

In some examples, the first non-transitory memory and the program code may be configured to, with the first processor, cause the apparatus to further: determine security category data associated with the at least one Type-1 device and the at least one Type-2 device; and receive digital scene data associated with the security category data from the at least one Type-1 device.

In some examples, the first non-transitory memory and the program code may be configured to, with the first processor, cause the apparatus to further: generate at least one additional Type-1 secure-ware and at least one additional Type-2 secure-ware based on the digital scene data and the security category data; and transmit the at least one additional Type-1 secure-ware and the at least one additional Type-2 secure-ware to the at least one Type-1 device.

In some examples, the digital scene data may be generated by the at least one Type-1 device based on sensing data received from the at least one Type-2 device.

In some examples, the at least one Type-1 secure-ware may cause the at least one Type-1 device to at least: review application or operating system access controls, analyze physical access to the systems, or perform security vulnerability scans. In some examples, the at least one Type-2 secure-ware may cause the at least one Type-2 device to at least: review application or operating system access controls, analyze physical access to the systems, or perform security vulnerability scans. In some examples, the digital scene data may indicate whether there is a cyber intrusion incident.

In accordance with various examples, a computer-implemented method is provided. The computer-implemented method may comprise: receiving location data associated with at least one Type-1 device and at least one Type-2 device; generating at least one Type-1 secure-ware for the at least one Type-1 device and at least one Type-2 secure-ware for the at least one Type-2 device based at least in part on the location data; transmitting the at least one Type-1 secure-ware and the at least one Type-2 secure-ware to the at least one Type-1 device; and causing the at least one Type-1 device to execute the at least one Type-1 secure-ware. In some examples, the at least one Type-1 secure-ware is configured to cause the at least one Type-1 device to transmit the at least one Type-2 secure-ware to the at least one Type-2 device.

In some examples, the computer-implemented method may further comprise: causing the at least one Type-1 device to at least: review application or operating system access controls, analyze physical access to the systems, or perform security vulnerability scans. In some examples, the computer-implemented method may further comprise: causing the at least one Type-2 device to at least: review application or operating system access controls, analyze physical access to the systems, or perform security vulnerability scans. In some examples, the digital scene data may indicate whether there is a cyber intrusion incident.

In accordance with various examples, a computer program product is provided. The computer program product may comprise at least one non-transitory computer-readable storage medium having computer-readable program code portions stored therein. The computer-readable program code portions may comprise an executable portion that is configured to: receive location data associated with at least one Type-1 device and at least one Type-2 device; generate at least one Type-1 secure-ware for the at least one Type-1 device and at least one Type-2 secure-ware for the at least one Type-2 device based at least in part on the location data; transmit the at least one Type-1 secure-ware and the at least one Type-2 secure-ware to the at least one Type-1 device; and cause the at least one Type-1 device to execute the at least one Type-1 secure-ware. In some examples, the at least one Type-1 secure-ware may be configured to cause the at least one Type-1 device to transmit the at least one Type-2 secure-ware to the at least one Type-2 device.

The foregoing illustrative summary, as well as other exemplary objectives and/or advantages of the disclosure, and the manner in which the same are accomplished, are further explained in the following detailed description and its accompanying drawings.

### BRIEF DESCRIPTION OF THE DRAWINGS

The description of the illustrative embodiments may be read in conjunction with the accompanying figures. It will be appreciated that, for simplicity and clarity of illustration, elements illustrated in the figures have not necessarily been drawn to scale, unless described otherwise. For example, the dimensions of some of the elements may be exaggerated relative to other elements, unless described otherwise. Embodiments incorporating teachings of the present disclosure are shown and described with respect to the figures presented herein, in which:

FIG. 1 illustrates an example schematic diagram of an example system in accordance with various embodiments of the present disclosure;

FIG. 2 illustrates an example block diagram of an example Type-1 device in accordance with various embodiments of the present disclosure;

FIG. 3 illustrates an example block diagram of an example Type-2 device in accordance with various embodiments of the present disclosure;

FIG. 4 illustrates an example schematic diagram of an example system in accordance with various embodiments of the present disclosure;

FIG. 5 illustrates an example flow diagram in accordance with various embodiments of the present disclosure;

FIG. 6 illustrates an example data flow diagram in accordance with various embodiments of the present disclosure;

FIG. 7 illustrates an example flow diagram in accordance with various embodiments of the present disclosure;

FIG. 8 illustrates an example data flow diagram in accordance with various embodiments of the present disclosure; and

FIG. 9 illustrates an example user interface in accordance with various embodiments of the present disclosure.

### DETAILED DESCRIPTION OF THE INVENTION

Some embodiments of the present disclosure will now be described more fully hereinafter with reference to the accompanying drawings, in which some, but not all embodiments of the disclosure are shown. Indeed, these disclosures may be embodied in many different forms and should not be construed as limited to the embodiments set forth herein; rather, these embodiments are provided so that this disclosure will satisfy applicable legal requirements. Like numbers refer to like elements throughout.

The phrases “in one embodiment,” “according to one embodiment,” “for example,” “in some examples,” “as an example,” and the like generally mean that the particular feature, structure, or characteristic following the phrase may be included in at least one embodiment of the present disclosure, and may be included in more than one embodiment of the present disclosure (such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such component or feature may be optionally included in some embodiments, or it may be excluded.

The term “electronically coupled,” “electronically coupling,” “electronically couple,” “in communication with,” “in electronic communication with,” or “connected” in the present disclosure refers to two or more components (for example but not limited to, Type-1 device, Type-2 device, botnet agent, secure botnet) being connected (directly or indirectly) through wired means (for example but not limited to, wired Ethernet) and/or wireless means (for example but not limited to, Wi-Fi, Bluetooth, ZigBee), such that data and/or information may be transmitted to and/or received from these components.

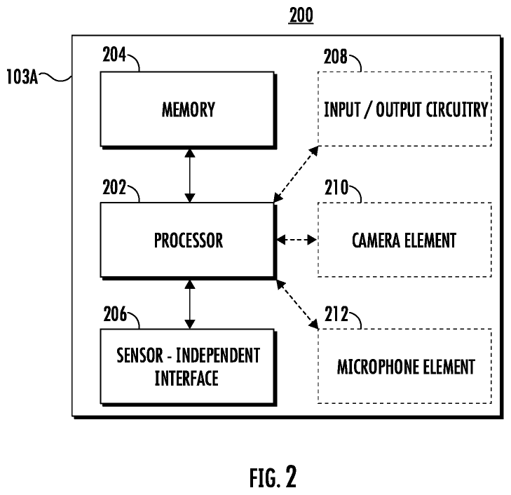

The term “Type-1 device” or “Type-1 secure-ware host” refers to an electronic device that is capable of storing and/or processing information and/or data. In some examples, a Type-1 device may comprise at least one processor and at least one non-transitory memory. For example, a Type-1 device may include a printed circuit board that may hold a central processing unit and a memory, and may provide connector(s) and interface(s) for other peripherals. For example, a Type-1 device may utilize a sensor independent interface so that it can be electronically coupled to one or more Type-2 devices via, for example but not limited to, a high-speed communication field bus. In some examples, a Type-1 device may comprise at least one of a camera element or a microphone element, and may provide computer vision and audio processing capabilities. An example Type-1 device is described and illustrated herein in connection with at least FIG. 2.

In some examples, a Type-1 device may act as a botnet host node that may host Type-1 secure-ware, details of which are described herein. In some examples, a Type-1 device may run computer software algorithms that are received on demand instantly, may operate one or more Type-2 devices remotely, and may collect data from one or more Type-2 devices for processing. In some examples, a Type-1 device may always be connected to a server and/or computing cloud (such as a “botnet agent”), details of which are described herein.

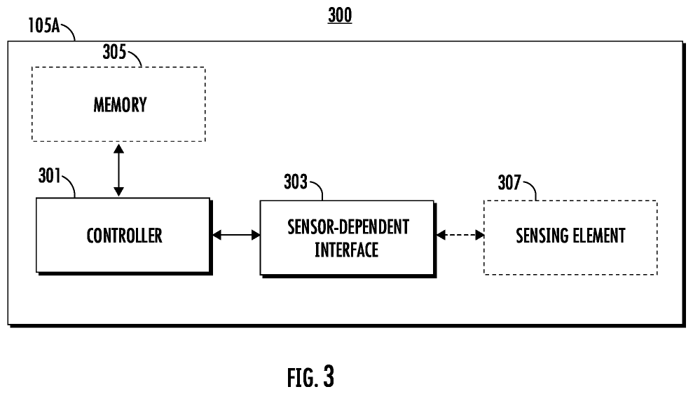

The term “Type-2 device” or “Type-2 secure-ware host” refers to a sensor node that is capable of gathering and communicating sensing data with one or more Type-1 devices. In some examples, a Type-1 device may receive a Type-2 secure-ware from a botnet agent, and may cause the Type-2 device to execute the Type-2 secure-ware on demand. In some examples, a Type-2 device may comprise a controller (such as a microcontroller) that may process data. In some examples, a Type-2 device may comprise an internal memory, and/or may communicate with an external memory. An example Type-2 device is described and illustrated herein in connection with at least FIG. 3.

In some examples, a Type-2 device may comprise at least one sensor-dependent interface that is configured to electronically couple the Type-2 device to one or more external or internal sensing elements. For example, a Type-2 device may receive multiple types of inputs (for example but not limited to, image sensor input, analogue input, audio input) to interface with the sensing element. In some examples, one or more sensing elements may be integrated into one Type-2 device, such that the Type-2 device may provide one or more sensing capabilities.

In some examples, a Type-2 device may be a sensor fusion device that has capability to connect to multiple sensors. In some examples, a Type-2 device may be a generic sensor plug-in module.

The term “sensing element” refers to a device or module that may detect events, changes, and/or stimulus (such as motion, pressure, sound, temperature) in its environment and send the resulting information to another device, such as a Type-2 device described above. Example sensing elements may include, but not limited to, motion sensor, pressure sensor, temperature sensor, passive infrared sensor, glass break sensor, smoke sensor, camera, and microphone.

The term “secure-ware” refers to a packaged firmware that may be generated by a botnet agent, and may be executed by a Type-1 device and/or Type-2 device. In some examples, secure-ware may be categorized based on the type of destined device. For example, a botnet agent may cause a Type-1 device to execute a Type-1 secure-ware. As another example, a botnet agent or a Type-1 device may cause a Type-2 device to execute a Type-2 secure-ware.

In some examples, a secure-ware may be generated using a software container, such that the secure-ware may be executed by the Type-1 device and/or the Type-2 device independent of other processes. In some examples, a secure-ware may comprise firmware(s) for the Type-1 device and/or Type-2 device. For example, a Type-1 secure-ware may comprise a firmware for a Type-1 device, and a Type-2 secure-ware may comprise a firmware for a Type-2 device.

In some examples, a secure-ware may comprise software drivers for one or more sensing elements. In some examples, a secure-ware may comprise software algorithms for collecting data (i.e. “data collection algorithms”), such as sensing data, that may be generated by sensing elements. In some examples, the data collection algorithms may cause the sensing elements to generate sensing data, and may convert the sensing data to other formats for communication, such as field bus protocol messages.

In some examples, a secure-ware may be one or more prices of complied code that is transmitted through a high-speed communication field bus to one or more Type-1 devices and/or one or more Type-2 devices. For example, upon executing a Type-1 secure-ware, a Type-1 device may relay one or more Type-2 secure-ware to one or more Type-2 devices, and may cause the one or more Type-2 devices to execute the one or more Type-2 secure-ware.

In some examples, a secure-ware may comprise a “life cycle indicator,” which indicates a time span for executing the secure-ware. For example, a life cycle indicator may indicate that the secure-ware has a life cycle of 30 seconds. Upon receiving the secure-ware, a Type-1 device or a Type-2 device may load and execute the secure-ware instantly, and stop executing the secure-ware after 30 seconds. In other words, the Type-1 device or the Type-2 device may exit the secure-ware after 30 seconds, and may become idle if there is no other software program running. In some examples, the life cycle indicator may be determined by a botnet agent when the corresponding secure-ware is generated.

The term “botnet” refers to a plurality of connected devices, including, but not limited to, electronically coupled devices. A “secure botnet” refers to a collection of connected Type-1 devices (“bots”) that are installed in a physical or virtual place or premises, such as (but not limited to) a warehouse, an apartment building, a residential house, an airport, a network system, a data warehouse, a data security center, and/or an Internet of Things (IoT) system. In some examples, secure-ware may be executed on demand on the Type-1 devices and/or Type-2 devices that are electronically coupled to the Type-1 devices. In these examples, these secure-ware may be configured to perform data gathering from the Type-2 devices utilizing one or more specified sensing technologies based on the sensing elements.

The term “botnet agent” refers to an application that is configured to generate secure-ware and create one or more botnets. In some examples, the botnet agent may be installed on an apparatus (i.e. “a botnet agent host”) that may have at least one processor and at least one non-transitory memory. When the program code of the botnet agent is executed by the botnet agent host, the botnet agent host may establish a botnet. For example, the botnet agent host may generate one or more secure-ware that are configured to process a variety of data that is captured by one or more Type-1 devices, and may transmit the one or more secure-ware to the one or more Type-1 devices through a botnet. In some examples, a botnet agent may incorporate artificial intelligent techniques, including but not limited to voice and/or image recognition techniques.

In some examples, a botnet agent host in accordance with examples of the present disclosure may be embodied by a networked device, such as a server or other network entity. Additionally, or alternatively, a botnet agent host may include computing devices, such as a personal computer or a computer workstation. Still further, a botnet agent host may be embodied by any of a variety of mobile devices, such as a portable digital assistant (PDA), mobile telephone, smartphone, laptop computer, tablet computer, wearable, or any combination of the aforementioned devices.

The term “security category” refers to a division of areas in a physical or virtual place or premises based on security risks. For example, Type-1 devices and Type-2 devices may be installed on locations in and around a residential house, where each location may be exposed to a different level of security risks. In some examples, “security category data” may be generated to indicate the security categories of the locations. For example, the security category data may indicate that a location is in a “red zone” (risk level higher than an upper limit), a “yellow zone” (risk level that falls within an upper limit and a lower limit), or a “green zone” (risk level lower than a lower limit). Additionally, or alternatively, the security category data may indicate the security category of a location based on the characteristics of the location (e.g. boiler room, living room, parking area). Additionally, or alternatively, the security category data may indicate the security category of a location based on a safety index. For example, the safety index may be a value ranging from 1 to 10, which represents the degree of potential safety risk that people in the location (for example, workers in a warehouse, residents in a house) may be exposed to.

The term “digital scene” refers to a distinguishable frame of incident or event happening in a security category. The term “digital scene data” refers to data generated by Type-1 device(s) and/or Type-2 device(s) that indicates a digital scene. For example, one or more Type-1 devices may be installed around a swimming pool area, which may be a “red zone” in the security category. These Type-1 devices, operating with one or more Type-2 devices installed around the area, may generate digital scene data when, for example, a person enters the area. Additional example details and implementations of digital scene data is described herein.

As described above, many exemplary systems and methods do not overcome technical challenges and difficulties associated with control systems. For example, many systems require purchasing multiple variants of hardware for similar products and maintaining a vast number of firmware source for a long period of time to support sensors and panels that sold in various regions, which may increase operation cost. As another example, many methods require individual management of life cycle of each electric part in the sensors and panels, which may decrease operation efficiency. Given the vast number of sensors and panels, it may be technical challenging (and may require a considerable amount of effort) to maintain different firmware application projects tailored for a particular sensing application, or to add integration protocols to each panel product and each sensor product variant.

As another example, converging physical security and cyber security in control system applications may impose technical challenges and difficulties in a hardware intensive and fixed firmware deployment model. For example, there may be a need for hardware security modules in case confidential information is stored on devices. Resource constraints may occur when security auditing algorithms are running along with the control system application all the time. Without mesh network capabilities or centralized analytics, it may be difficult to detect cyber-physical attacks or attack attempt.

In contrast, various examples in accordance with examples of the present disclosure may overcome these challenges and difficulties. In some examples, a secure botnet may be created for centralized command and control, allowing packaged firmware (i.e. secure-ware) to be downloaded and executed in the various devices on demand. For example, machine learning algorithms may be implemented to work in a cloud environment and to deploy secure-ware to various devices deployed on a place or premises. Because these devices may be dedicated hardware resources on site, various examples of the present disclosure may provide the flexibility to scale existing deployment models for control systems. Because these devices may be standardized hardware platforms, the amount of firmware to maintain throughout the product life cycle may be minimized. As such, various examples of the present disclosure may reduce the amount of firmware and hardware variants in the control system deployment, and may standardize the firmware and hardware that is deployed in mass in customer sites.

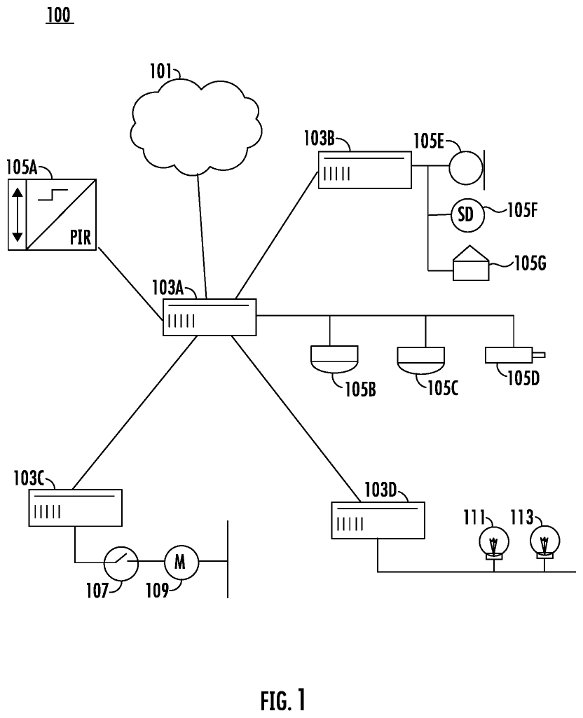

FIG. 1 illustrates an example system architecture 100 within which embodiments of the present disclosure may operate. The system may comprise at least one botnet agent host (for example, a botnet agent host 101), at least one Type-1 device (for example, Type-1 devices 103A, 103B, 103C, 103D), and at least one Type-2 device (for example, Type-2 devices 105A, 105B, 105C, 105D, 105E, 105F, 105G). In some examples, the system may comprise a relay element 107, a motor element 109, and/or light elements 111 and 113.

As described above, the botnet agent host 101 may be a networked device, such as a server. In some examples, a user may access the botnet agent host 101 via a client device, such as, but not limited to, desktop computers, laptop computers, smartphones, netbooks, tablet computers, wearables, and the like.

In embodiments where a client device is a mobile device (such as a smart phone or tablet), the client device may execute an “app” to interact with the botnet agent host 101. Such apps are typically designed to execute on mobile devices, such as tablets or smartphones. For example, an app may be provided that executes on mobile device operating systems such as IOS®, ANDROID®, or WINDOWS®. These platforms typically provide frameworks that allow apps to communicate with one another and with particular hardware and software components of mobile devices. For example, the mobile operating systems named above each provide frameworks for interacting with wired and wireless network interfaces and other applications.

Additionally, or alternatively, a client device may interact with the botnet agent host 101 via a web browser or through a web application that runs in a web browser. As yet another example, the botnet agent host 101 may include various hardware or software that are configured to allow a user to interact with the botnet agent host 101 directly via a user interface without the need for a separate client device.

Referring back to FIG. 1, the botnet agent host 101 may be connected to and in electronic communications with one or more Type-1 devices, such as the Type-1 device 103A. As described above, the botnet agent host 101 may generate one or more secure-ware for Type-1 device(s) and Type-2 device(s), and may transmit the secure-ware to one or more Type-1 devices. In some examples, the botnet agent host 101 may generate the secure-ware based on the location data associated with the Type-1 device(s) and the Type-2 device(s), details of which are described herein.

In some examples, one or more Type-1 devices in an example system may be connected directly to the botnet agent host 101. For example, the Type-1 device 103A may be directly connected to the botnet agent host 101, as shown in FIG. 1. In some examples, the connection between the botnet agent host 101 and a Type-1 device (such as the Type-1 device 103A) may be based on a high-speed communication bus protocol (for example, Fieldbus).

In some examples, one or more Type-1 devices in an example system may be connected to the botnet agent host 101 via one or more intermediaries, such as other Type-1 device(s). For example, the Type-1 devices 103B, 103C, and 103D may be connected to the botnet agent host 101 via the Type-1 device 103A, as shown in FIG. 1. In some examples, the connection between Type-1 devices may be based on a high-speed communication bus protocol (for example, Fieldbus).

Additionally, or alternatively, the connection between a botnet agent host and Type-1 device(s) and/or between Type-1 devices (“botnet path”) may include one or more wired or wireless communication networks including, for example, a wired or wireless local area network (LAN), personal area network (PAN), metropolitan area network (MAN), wide area network (WAN), or the like, as well as any hardware, software and/or firmware required to implement the one or more networks (such as, for example, network routers). For example, the connection may include general packet radio service (GPRS) network, Code Division Multiple Access 2000 (CDMA2000) network, Wideband Code Division Multiple Access (WCDMA) network, Global System for Mobile Communications (GSM) network, Enhanced Data rates for GSM Evolution (EDGE) network, Time Division-Synchronous Code Division Multiple Access (TD-SCDMA) network, Long Term Evolution (LTE) network, High Speed Packet Access (HSPA) network, High-Speed Downlink Packet Access (HSDPA) network, IEEE 802.11 (Wi-Fi), Wi-Fi Direct, and/or IEEE 802.16 (WiMAX). Additionally, or alternatively, the connection may include a public network (such as the Internet), a private network (such as an intranet), or combinations thereof, and may utilize networking protocols including, but not limited to, TCP/IP based networking protocols, near field communication (NFC) protocols, Bluetooth protocols, and/or ZigBee protocols.

Referring back to FIG. 1, each of the Type-2 devices (such as Type-2 devices 105A, 105B, 105C, 105D, 105E, 105F, 105G) may be connected to one or more Type-1 devices. For example, Type-2 devices 105A, 105B, 105C, and 105D may be connected to the Type-1 device 103A. As another example, Type-2 devices 105E, 105F, and 105G may be connected to the Type-1 device 103B. The connection between the Type-1 devices and Type-2 devices may be based on a high-speed communication bus protocol (for example, Fieldbus) and/or other techniques as described above.

In some examples, the Type-2 devices may be electronically coupled to one or more sensing elements, and may communicate sensing data from the sensing elements to the Type-1 devices. For example, the Type-2 device 105A may communicate sensing data from a passive infrared sensor to the Type-1 device 103A. As another example, the Type-2 devices 105B and 105C may communicate sensing data from image sensors to the Type-1 device 103A. As another example, the Type-2 device 105D may communicate sensing data from a motion sensor to the Type-1 device 103A. As another example, the Type-2 devices 105E, 105F, and 105G may communicate sensing data from a microphone, a smoke detector, and a glass break detector, respectively, to the Type-1 device 103B.

In some examples, a Type-1 device may be connected to devices other than, or in addition to, Type-2 devices. For example, as shown in FIG. 1, the Type-1 device 103C may be connected to a motor element 109 via a relay element 107. The Type-1 device 103D may be connected to light elements 111 and 113. In some examples, the Type-1 device 103C may cause the motor element 109 to operate, and/or the Type-1 device 103D may cause the light elements 111 and/or 113 to illuminate.

Referring now to FIG. 2, an example block diagram 200 illustrating various components of an example Type-1 device 103A in accordance with examples of the present disclosure is shown. For example, the example Type-1 device 103A may comprise at least one processor (such as a processor 202), at least one non-transitory memory (such as a memory 204), and/or a sensor-independent interface 206. In some examples, the example Type-1 device 103A may comprise an input/output circuitry 208, a camera element 210, and/or a microphone element 212.

Although these components may be described with respect to functional limitations, it should be understood that the particular implementations necessarily include the use of particular hardware. It should also be understood that certain of these components may include similar or common hardware. For example, two sets of circuitries may both leverage use of the same processor, network interface, storage medium, or the like to perform their associated functions, such that duplicate hardware is not required for each set of circuitries.

In some examples, the processor 202 (and/or co-processor or any other processing circuitry assisting or otherwise associated with the processor) may be in communication with the memory 204 via a bus for passing information among components of the Type-1 device 103A. For example, a printed circuit board may hold both the processor 202 and the memory 204.

The memory 204 may be non-transitory and may include, for example, one or more volatile and/or non-volatile memories. In other words, for example, the memory 204 may be an electronic storage device (e.g., a computer-readable storage medium). The memory 204 may be configured to store information, data, content, applications, instructions (such as but not limited to secure-ware) for enabling the Type-1 device 103A to carry out various functions in accordance with examples of the present disclosure.

The processor 202 may be embodied in a number of different ways. In some examples, the processor 202 may include one or more processing modules configured to perform independently. For example, the processor 202 may include one or more processors configured in tandem via a bus to enable independent execution of instructions, pipelining, and/or multithreading. The use of the term “processor” or “processing circuitry” may be understood to include a single core processor, a multi-core processor, multiple processors, and the like.

In some examples, the processor 202 may be configured to execute secure-ware stored in the memory 204 or otherwise accessible to the processor 202. As such, whether configured by hardware or software methods, or by a combination thereof, the processor 202 may represent an entity (e.g., physically embodied in circuitry) capable of performing operations according to an example of the present disclosure while configured accordingly.

Referring back to FIG. 2, the sensor-independent interface 206 may be configured to enable the Type-1 device 103A to be electronically coupled to and communicate with one or more Type-2 devices regardless of the sensing element(s) associated with the one or more Type-2 devices. In some examples, the sensor-independent interface 206 may be any means such as a device or circuitry embodied in either hardware or a combination of hardware and software that is configured to receive and/or transmit data from/to a network and/or other device, circuitry, or module (such as Type-2 devices) in communication with the Type-1 device 103A. In some examples, the sensor-independent interface 206 may include, for example, a network interface for enabling communications with a wired or wireless communication network, including but not limited to the high-speed communication bus (Fieldbus) described above. For example, the sensor-independent interface 206 may include one or more network interface cards, antennae, buses, switches, routers, modems, and supporting hardware and/or software, or any other device suitable for enabling communications via a network. Additionally, or alternatively, the sensor-independent interface 206 may include the circuitry for interacting with the antenna/antennae to cause transmission of signals via the antenna/antennae or to handle receipt of signals received via the antenna/antennae.

In some examples, the Type-1 device 103A may optionally include input/output circuitry 208 that may, in turn, be in communication with processor 202 to provide output to the user and, in some embodiments, to receive an indication of a user input. The input/output circuitry 208 may comprise a user interface circuitry and may include a display, which may comprise a web user interface, a mobile application, a client device, a kiosk, or the like. In some embodiments, the input/output circuitry 208 may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 204, and/or the like).

In some examples, the Type-1 device 103A may optionally include a camera element 210 that is configured to capture still image data and/or moving image data, and transmit said image data to the processor 202 for processing. In some examples, the Type-1 device 103A may optionally include a microphone element 212 that is configured to capture audio data, and transmit said audio data to the processor 202 for processing. In some examples, the Type-1 device 103A may optionally include a speaker element that is configured to output an audio signal (such as an audio warning message).

In some embodiments, additional elements of the Type-1 device 103A may provide or supplement the functionality of particular circuitry. For example, additional processor(s) may provide processing functionality, additional memory(s) may provide storage functionality, additional communication circuitries may provide network interface functionality, and/or the like.

Referring now to FIG. 3, an example block diagram 300 illustrating various components of an example Type-2 device 105A in accordance with examples of the present disclosure is shown. For example, the example Type-2 device 105A may comprise at least one controller (such as a controller 301) and/or a sensor-dependent interface 303. In some examples, the example Type-2 device 105A may comprise a memory 305 and/or at least one sensing element (such as a sensing element 307). Although these components may be described with respect to functional limitations, it should be understood that the particular implementations necessarily include the use of particular hardware. It should also be understood that certain of these components may include similar or common hardware.

In some examples, the controller 301 may be embodied in a number of different ways. For example, the controller 301 may be a microcontroller. As another example, the controller 301 may be a general purpose processor.

The controller 301 may process data and control one or more sensing elements that are connected to the Type-2 device 105A. For example, the controller 301 may execute secure-ware received by the Type-2 device 105A, and may control and operate one or more sensing elements. In some examples, the controller 301 may process sensing data received from the one or more sensing elements, and may and transmit the sensing data to one or more Type-1 devices, details of which are described herein. In some examples, the controller 301 may be in communication with the memory 305 integrated within the Type-2 device 105A. In some examples, the controller 301 may be in communication with a memory that is external to the Type-2 device 105A.

Referring back to FIG. 3, the sensor-dependent interface 303 may be configured to enable the Type-2 device 105A to be electronically coupled to and communicate with at least one sensing element (such as the sensing element 307). In some examples, the sensor-dependent interface 303 may be configured to process certain sensing data based on the sensing element(s) that the Type-2 device is connected to. For example, the sensor-dependent interface 303 may comprise a module that is specifically configured to process image sensor input data when the Type-2 device is electronically coupled to an image sensor. As another example, if the Type-2 device is electronically coupled to a microphone element, the sensor-dependent interface 303 may comprise a module that is specifically configured to process the audio input data from the microphone.

In some examples, the sensor-dependent interface 303 may be any means such as a device or circuitry embodied in either hardware or a combination of hardware and software that is configured to receive and/or transmit data from/to a network and/or other device, circuitry, or module (such as sensing element(s)) in communication with the Type-2 device 105A. In some examples, the sensor-dependent interface 303 may include, for example, a network interface for enabling communications with a wired or wireless communication network. For example, the sensor-dependent interface 303 may include one or more network interface cards, antennae, buses, switches, routers, modems, and supporting hardware and/or software, or any other device suitable for enabling communications via a network. Additionally, or alternatively, the sensor-dependent interface 303 may include the circuitry for interacting with the antenna/antennae to cause transmission of signals via the antenna/antennae or to handle receipt of signals received via the antenna/antennae.

In some examples, one or more sensing elements may be integrated within a Type-2 device, such as the sensing element 307 as shown in FIG. 3. In some examples, one or more sensing elements that are external to a Type-2 device may be connected to the Type-2 device via a sensor-dependent interface (such as the sensor-dependent interface 303 as shown in FIG. 3).

In some examples, additional elements of the Type-2 device 105A may provide or supplement the functionality of particular circuitry. For example, additional processor(s) may provide processing functionality, additional memory(s) may provide storage functionality, additional transceivers may communicate data to and from other devices, and/or the like.

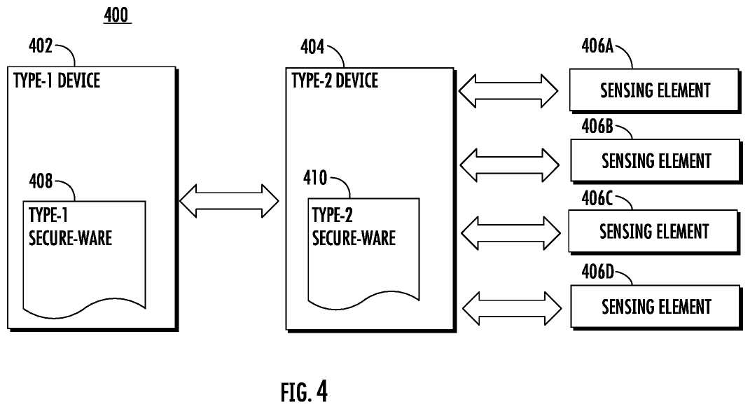

Referring now to FIG. 4, an example block diagram 400 is shown, illustrating various connections between a Type-1 device 402, a Type-2 device 404, and sensing elements 406A, 406B, 406C, and 406D.

The Type-1 device 402 may receive a Type-1 secure-ware 408 from a botnet agent host, and may execute the Type-1 secure-ware 408 during its life cycle as indicated by the life cycle indicator. In some examples, the botnet agent host may cause the Type-1 device 402 to exit the at least one Type-1 secure-ware based on the at least one life cycle indicator.

In some examples, the Type-1 secure-ware 408 may comprise firmware for the Type-1 device 402. In some examples, the Type-1 secure-ware 408 may comprise data collection algorithms that may facilitate the collection of data (such as digital scene data) by the Type-1 device 402.

While executing the Type-1 secure-ware 408, the Type-1 device 402 may communicate data to and/or from the Type-2 device 404 via a sensor-independent interface. As described above, the sensor-independent interface may enable the Type-1 device 402 to communicate with any Type-2 device, regardless of the type of sensing element associated with the Type-2 device. As such, sensor-independent interface may provide flexibility in deploying the Type-1 devices and Type-2 devices.

In some examples, the Type-1 device 402 may transmit the Type-2 secure-ware 410 to Type-2 device 404, and may cause the Type-2 device 404 to execute the Type-2 secure-ware 410. In some examples, the Type-1 device 402 may receive sensing data from the Type-2 device 404, and may process the sensing data to generate digital scene data, details of which are described herein.

Referring back to FIG. 4, while executing the Type-2 secure-ware 410, the Type-2 device 404 may communicate data to and/or from the sensing elements 406A, 406B, 406C, and 406B via a sensor-dependent interface. As described above, the sensor-dependent interface may be configured to process specific sensing data from the sensing elements 406A, 406B, 406C, and 406B.

In some examples, the Type-2 secure-ware 410 may comprise software drivers for the sensing elements 406A, 406B, 406C, and 406B, thus enabling the Type-2 device 410 to control and operate the sensing elements 406A, 406B, 406C, and 406B. In some examples, the Type-2 secure-ware 410 may comprise firmware for the Type-2 device 404. In some examples, the Type-2 secure-ware 410 may comprise data collection algorithms that may facilitate the collection of data (such as sensing data) by the Type-2 device 404. In some examples, the Type-2 secure-ware 410 may comprise a life cycle indicator, which may indicate the life cycle of the Type-2 secure-ware 410.

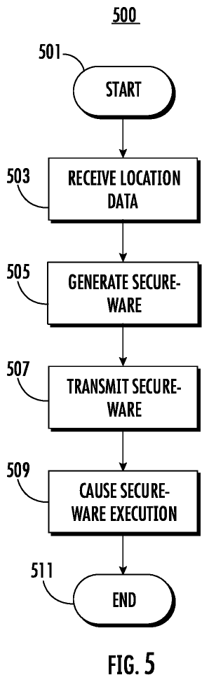

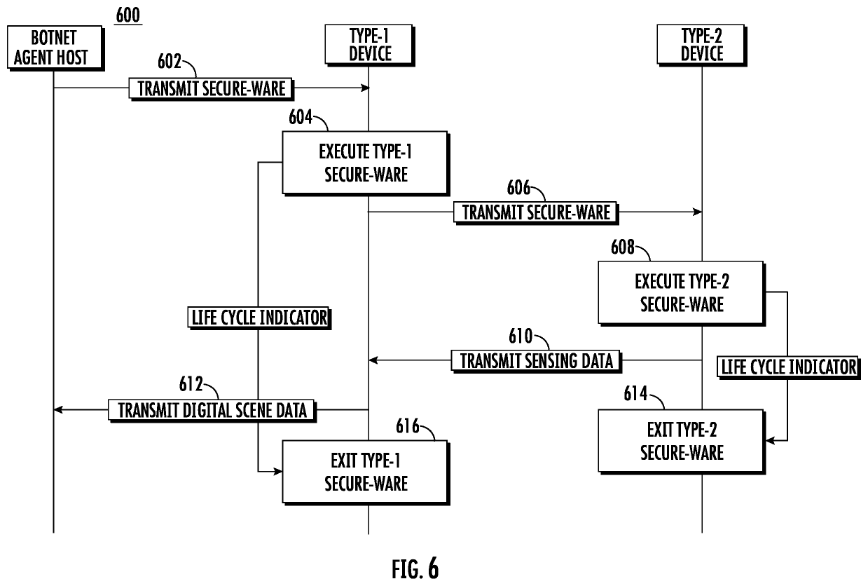

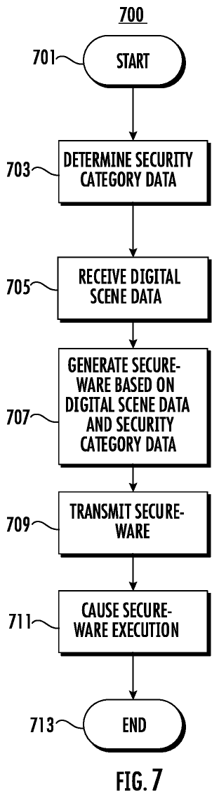

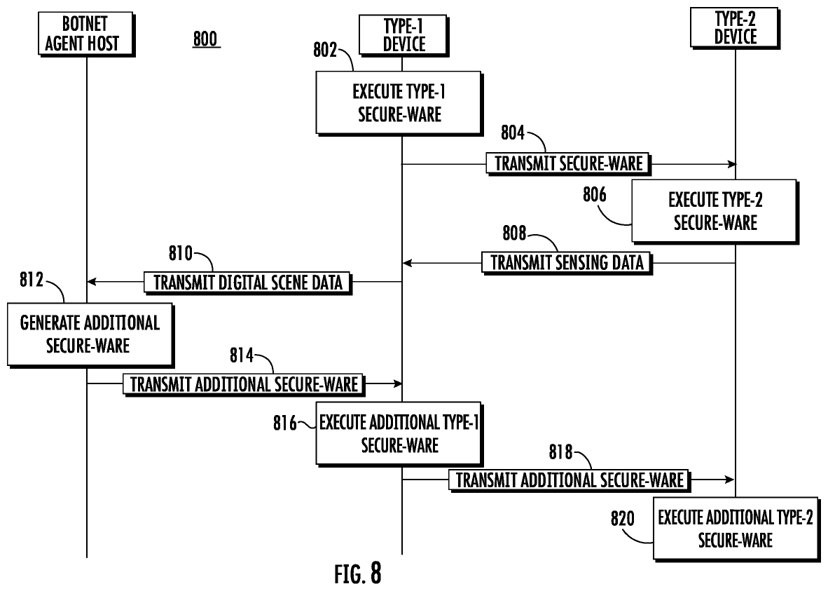

Referring now to FIG. 5, FIG. 6, FIG. 7, and FIG. 8, example methods in accordance with various embodiments of the present disclosure are illustrated. In some examples, each block or step of the flowchart, and combinations of blocks and steps in the flowchart, may be implemented by various means such as hardware, circuitry and/or other devices associated with execution of software including one or more computer program instructions.

In some examples, one or more of the procedures described in figures may be embodied by computer program instructions, which may be stored by a memory circuitry (such as a non-transitory memory) of an apparatus employing an embodiment of the present disclosure and executed by a processing circuitry (such as a processor) of the apparatus. These computer program instructions may direct the apparatus to function in a particular manner, such that the instructions stored in the memory circuitry produce an article of manufacture, the execution of which implements the function specified in the flowchart block(s). Further, the apparatus may comprise one or more other components, such as, for example, a communication circuitry and/or an input/output circuitry. Various components of the apparatus may be in electronic communication between and/or among each other to transmit data to and/or receive data from each other.

In some examples, embodiments may take the form of a computer program product on a non-transitory computer-readable storage medium storing computer-readable program instructions (e.g. computer software). Any suitable computer-readable storage medium may be utilized including non-transitory hard disks, CD-ROMs, flash memory, optical storage devices, or magnetic storage devices.

Referring back to FIG. 5, an example method 500 in accordance with some embodiments of the present disclosure is illustrated. In particular, the example method 500 may illustrate example embodiments of configuring a secure botnet. In some examples, the method 500 may be performed by a processing circuitry (for example, a processing circuitry of the botnet agent host 101 described above in connection with FIG. 1).

The method 500 starts at block 501.

At block 503, a processing circuitry (for example, a processing circuitry of the botnet agent host 101 described above in connection with FIG. 1) may receive location data associated with at least one Type-1 device and at least one Type-2 device.

In some examples, the processing circuitry may receive the location data from a data storage device (such as a database) that is connected to the botnet agent host. In some examples, the processing circuitry may receive the location data from the at least one Type-1 device and/or the at least one Type-2 device. For example, a Type-1 device may transmit location data associated with one or more Type-2 devices that the Type-1 device is connected to. In some examples, a user may input the location data to the botnet agent host via a client device. For example, a user operating a client device may type, via a user interface generated by the botnet agent host, the locations of the at least one Type-1 device and the at least one Type-2 device.

In some examples, the location data may include geolocation data that indicates the installation locations of the at least one Type-1 device and the at least one Type-2 device. For example, the location data may indicate the global positioning system (GPS) coordinates of the at least one Type-1 device and the at least one Type-2 device.

In some examples, the location data may include relative location data that may indicate the relative location between Type-1 devices, between Type-2 devices, and/or between a Type-1 device and a Type-2 device. The relative location data may indicate the spatial relationship between two devices. For example, the location data may indicate that a Type-2 device is installed within a field of view of a camera element of a Type-1 device. As another example, the location data may indicate that a Type-2 device is installed 5 meters south of a Type-1 device. As another example, the location data may indicate that a Type-2 device is installed within a pre-determined distance (such as 5 meters) from a Type-1 device.

In some examples, the location data may include a location descriptor, which may comprise a text that describes the location of a device. For example, the location descriptor may describe that a Type-2 device is installed in a swimming pool.

At block 505, a processing circuitry (for example, a processing circuitry of the botnet agent host 101 described above in connection with FIG. 1) may generate at least one Type-1 secure-ware for the at least one Type-1 device and at least one Type-2 secure-ware for the at least one Type-2 device.

As described above, a secure-ware is a packaged firmware that may include software drivers for the sensing elements and data collection algorithms. In some examples, a secure-ware may include a life cycle indicator that indicates the life cycle of the secure-ware.

In some examples, the processing circuitry may generate the secure-ware based at least in part on the location data, including geolocation data and/or relative location data. Continuing from one of the examples above, the location data may indicate that a Type-2 device is installed within a field of view of a camera element of a Type-1 device. In this example, the processing circuitry may generate a Type-2 secure-ware that may cause the Type-2 device to communicate sensing data to the Type-1 device. Continuing from another one of the examples above, the location data may indicate that a Type-2 device is installed within a predetermined distance from a Type-1 device, and the processing circuitry may generate a Type-2 secure-ware that may cause the Type-2 device to communicate sensing data to the Type-1 device.

Additionally, or alternatively, the processing circuitry may generate the secure-ware based at least in part on user input. For example, a user operating a client device may transmit one or more selections of one or more Type-1 devices and/or Type-2 device(s) to the processing circuitry. Upon receiving the selections, the processing circuitry may configure and generate secure-ware for the selected Type-1 device(s) and Type-2 device(s).

Additionally, or alternatively, the processing circuitry may generate the secure-ware based at least in part on the digital scene data received from the at least one Type-1 device, details of which are described in connection with at least FIG. 7 and FIG. 8.

At block 507, a processing circuitry (for example, a processing circuitry of the botnet agent host 101 described above in connection with FIG. 1) may transmit the at least one Type-1 secure-ware and the at least one Type-2 secure-ware to the at least one Type-1 device.

As described above, the Type-1 secure-ware and the Type-2 secure-ware may be transmitted to the at least one Type-1 device based on a high-speed communication bus protocol (such as Fieldbus). In some examples, the secure-ware may be transmitted via wired and/or wireless means.

At block 509, a processing circuitry (for example, a processing circuitry of the botnet agent host 101 described above in connection with FIG. 1) may cause the at least one Type-1 device to execute the at least one Type-1 secure-ware.

In some examples, the processing circuitry may remotely manage the operation(s) of the at least one Type-1 device. For example, the processing circuitry may remotely activate and/or deactivate a camera element of the Type-1 device, and may access image data captured by the camera element. As another example, the processing circuitry may remotely activate and/or deactivate a microphone element of the Type-1 device, and may access the audio data captured by the microphone element. As another example, the processing circuitry may remotely activate and/or deactivate a motor element and/or a light element that is connected to the Type-1 device.

In some examples, the processing circuitry may remotely cause the at least one Type-1 device to relay the at least one Type-2 secure-ware to the at least one Type-2 device. For example, the at least one Type-1 secure-ware may comprise program code that, when executed, cause the at least one Type-1 device to transmit the at least one Type-2 secure-ware to the at least one Type-2 device. In some examples, the at least one Type-1 device may further cause the at least one Type-2 device to execute the at least one Type-2 secure-ware, example details of which are described in connection with at least FIG. 6.

The method 500 ends at block 511.

Referring now to FIG. 6, an example data flow diagram 600 in connection with various examples of the present disclosure is illustrated. In particular, the example data flow diagram 600 illustrates various example data communications between an example botnet agent host, an example Type-1 device, and an example Type-2 device.

At step 602, the example botnet agent host may transmit secure-ware to the example Type-1 device, similar to those described above in connection with block 507 of FIG. 5 above. Upon receiving the secure-ware, the example Type-1 device may execute the Type-1 secure-ware at step 604, and may transmit the Type-2 secure-ware to the example Type-2 device at step 606.

At step 608, the example Type-2 device may execute the Type-2 secure-ware. In some examples, the example Type-2 device may be connected to one or more sensing elements, and the Type-2 secure-ware may include software drivers for these sensing elements. As such, the example Type-2 device may activate and operate these sensing elements. In some examples, the Type-2 secure-ware may comprise data collection algorithms, which may cause the example Type-2 device to collect sensing data generated by the sensing elements and transmit sensing data to the example Type-1 device at step 610.

For example, a Type-2 device may be connected to a passive infrared sensor, such as the Type-2 device 105A describe above in connection with FIG. 1. Upon executing the Type-2 secure-ware, the Type-2 device may transfer its device control to a Type-1 device, and the Type-1 device may cause the Type-2 device to activate the passive infrared sensor. The Type-2 device may receive sensing data (indicating infrared light radiation) that is generated by the passive infrared sensor. The Type-2 device may transmit the sensing data to the Type-1 device at step 610.

As another example, a Type-2 device may be connected to an image sensor, such as the Type-2 devices 105B and 105C described above in connection with FIG. 1. The Type-2 secure-ware may cause the Type-2 device to activate the image sensor, and the Type-2 device may receive sensing data generated by the image sensor. The Type-2 device may transmit the sensing data to the Type-1 device at step 610.

In some examples, the example Type-2 device may continue executing the Type-2 secure-ware until it reaches the end of life cycle of the Type-2 secure-ware (as indicated by the life cycle indicator of the Type-2 secure-ware). When the end of life cycle is reached, the example Type-2 device may exit the Type-2 secure-ware, and may become idle at step 614. For example, if the life cycle is 30 seconds, the example Type-2 device may stop collecting and transmitting sensing data 30 seconds subsequent to performing step 608.

Upon receiving the sensing data, the example Type-1 device may generate digital scene data based on the sensing data. In some examples, the Type-1 secure-ware may comprise machine learning algorithms that enable the Type-1 device to analyze the sensing data to determine the occurrence of a distinguishable frame of incident or event. For example, the Type-1 secure-ware may comprise image recognition algorithm that allows the Type-1 device to analyze image sensing data transmitted by the Type-2 device so as to determine the presence of people in the premises where the Type-2 device is installed.

At step 612, the example Type-1 device may transmit the digital scene data to the botnet agent host. In some examples, the botnet agent host may analyze the digital scene data, and may generate additional secure-ware based on the digital scene data, details of which are described in connection with at least FIG. 7 and FIG. 8.

In some examples, the example Type-1 device may continue executing the Type-1 secure-ware until it reaches the end of life cycle of the Type-1 secure-ware (as indicated by the life cycle indicator of the Type-1 device). When the end of life cycle is reached, the example Type-1 device may exit the Type-1 secure-ware, and may become idle at step 616. For example, if the life cycle is 30 seconds, the example Type-1 device may exit the Type-1 secure-ware after 30 seconds from performing step 604.

Referring to FIG. 7, an example method 700 in accordance with some embodiments of the present disclosure is illustrated. In particular, the example method 700 may illustrate example embodiments of reconfiguring a secure botnet. In some examples, the method 700 may be performed by a processing circuitry (for example, a processing circuitry of the botnet agent host 101 described above in connection with FIG. 1).

The method 700 starts at block 701.

At block 703, a processing circuitry (for example, a processing circuitry of the botnet agent host 101 described above in connection with FIG. 1) may determine security category data associated with the at least one Type-1 device and the at least one Type-2 device.

In some examples, the processing circuitry may determine the security category data based on the location data. For example, as described above in connection with block 503 of FIG. 5, the processing circuitry may receive location data associated with the at least one Type-1 device and the at least one Type-2 device. The processing circuitry may analyze the location data to determine the corresponding security category of each location where the at least one Type-1 device and the at least one Type-2 device are installed in or associated with.

For example, the processing circuitry may determine that a sensing element connected to a Type-2 device is installed in a location that is a “red zone” (high risk area), a “yellow zone” (medium risk area), or a “green zone” (low risk area). Additionally, or alternatively, the processing circuitry may determine that a Type-1 device is installed in a boiler room, living room, parking area, or the like. Additionally, or alternatively, the processing circuitry may calculate a safety index for each Type-1 device and Type-2 device.

As an example, a processing circuitry may determine that a swimming pool area is a “red zone” in the security category. The processing circuitry may determine that (based on the location data) a camera element of a Type-1 device faces the swimming pool area, and may determine the corresponding security category data of the Type-1 device to indicate “red zone” security category. Similarly, the processing circuitry may determine that a Type-2 device connected to water level/wave sensing elements installed in the swimming pool are within the “red zone” security category.

At block 705, a processing circuitry (for example, a processing circuitry of the botnet agent host 101 described above in connection with FIG. 1) may receive digital scene data from the at least one Type-1 device, similar to step 612 described above in connection with FIG. 6.

As described above, the digital scene data may indicate a distinguishable frame of incident or event. In some examples, the digital scene data may be associated with the security category data. Continuing from the above example related to a swimming pool area (which may a “red zone”), the digital scene data may indicate that a child is in the swimming pool.

At block 707, a processing circuitry (for example, a processing circuitry of the botnet agent host 101 described above in connection with FIG. 1) may generate at least one additional Type-1 secure-ware and/or at least one additional Type-2 secure-ware based on the digital scene data and the security category data.

As an example, the digital scene data and the security category data may indicate that a child is crawling (digital scene) towards a swimming pool area (a “red zone” security category). Based on the digital scene data and the security category data, the processing circuitry may generate an additional Type-1 secure-ware for a Type-1 device installed near the swimming pool area. The additional Type-1 secure-ware may cause the Type-1 device to output an audio warning message via a speaker element.

As another example, the digital scene data and the security category data may indicate that an elderly has fallen (digital scene) near a toilet (a “yellow zone” security category), and the injury has caused bleeding. Based on the digital scene data and the security category data, the processing circuitry may generate an additional Type-1 secure-ware that may cause a Type-1 device to activate a medical emergency alarm.

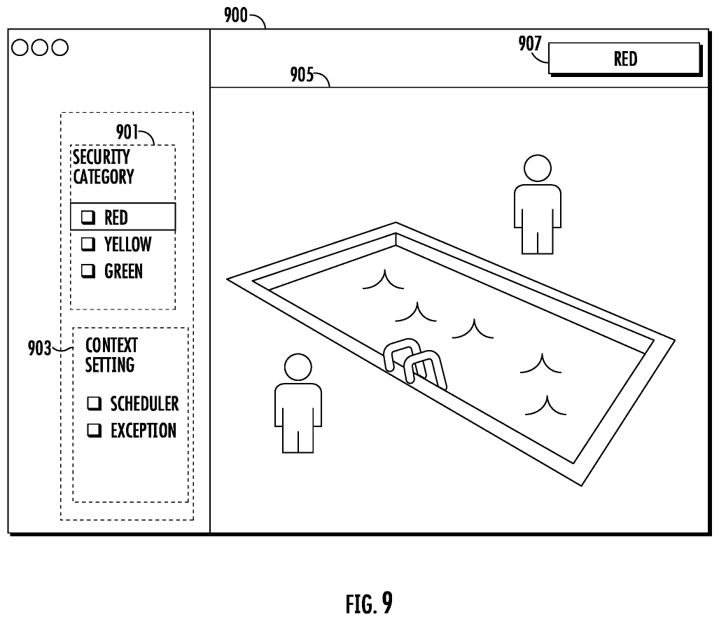

As shown in the above non-limiting examples, the botnet agent host may provide dynamic reconfiguration of the botnet for the specific class of incident associated with a security category. This approach may provide unique intimations for incidents based on the security category. For example, categorical groupings may facilitate proactively managing the incidents in the areas, creating scenes based on safety risks in specific areas, applying an operational preset by selecting scenes and security category, example details are described in connection with at least FIG. 8 and FIG. 9.

At block 709, a processing circuitry (for example, a processing circuitry of the botnet agent host 101 described above in connection with FIG. 1) may transmit the at least one additional Type-1 secure-ware and the at least one additional Type-2 secure-ware to the at least one Type-1 device, similar to those described above in connection with at least block 507 of FIG. 5 above.

At block 711, a processing circuitry (for example, a processing circuitry of the botnet agent host 101 described above in connection with FIG. 1) may cause the at least one Type-1 device to execute the at least one additional Type-1 secure-ware. In some examples, the at least one additional Type-1 secure-ware may be configured to cause the at least one Type-1 device to transmit the at least one additional Type-2 secure-ware to the at least one Type-2 device, similar to those described above in connection with at least block 509 of FIG. 5.

The method 700 ends at block 713.

Referring now to FIG. 8, an example data flow diagram 800 in connection with various examples of the present disclosure is illustrated. In particular, the example data flow diagram 800 illustrates various example data communications between an example botnet agent host, an example Type-1 device, and an example Type-2 device.

At step 802, the Type-1 device may execute a Type-1 secure-ware, similar to step 604 described above in connection with FIG. 6. At step 804, the Type-1 device may transmit a Type-2 secure-ware to the Type-2 device, similar to step 606 described above in connection with FIG. 6. At step 806, the Type-2 device may execute the Type-2 secure-ware, similar to step 608 described above in connection with FIG. 6.

At step 808, the Type-2 device may transmit sensing data to the Type-1 device, similar to step 610 described above in connection with FIG. 6.

In some examples, the Type-2 device may be a sensor fusion device that has the capability to connect to multiple sensors. In some examples, the Type-2 device may be a generic sensor plug-in module. In some examples, the Type-2 device may have multiple stock keeping unit (SKU) identifications.

For example, the Type-2 device may be installed in a residential house, and may be connected to one or more of the following sensing elements: a passive infrared sensor, a glass break sensor, a smoke sensor, and/or a heat sensor. In this example, the sensing data may indicate one or more of infrared light radiation, glass break indication, smoke signal and/or heat signal.

At step 810, the Type-1 device may generate and transmit digital scene data to the botnet agent host, similar to step 612 described above in connection with FIG. 6.

Continuing from the above example, the Type-1 device may determine that there is an intrusion event in the residential house based on the sensing data received from the Type-2 device. For example, the sensing data may comprise a glass break indication that indicates a glass window of the residential house is broken. The Type-1 device may generate digital scene data indicating the home intrusion event, and may transmit the digital scene data to the botnet agent host.

In some examples, the Type-1 secure-ware installed on the Type-1 device may cause the Type-1 device to only generate digital scene data for a predetermined period of time. For example, the Type-1 secure-ware may cause the Type-1 device to only generate digital scene data between 12 a.m. and 8 a.m. everyday.

At step 812, the botnet agent host may generate additional Type-1 secure-ware(s) and/or additional Type-2 secure-ware(s) based on the digital scene data and the security category data, similar to those described above in connection with block 707 of FIG. 7.

In some examples, the botnet agent host may select one or more Type-1 device(s) and/or Type-2 device(s) in addition to or in alternative of the Type-1 device and/or the Type-2 device in FIG. 8, and may generate additional secure-ware for these selected Type-1 device(s) and/or Type-2 device(s). In some examples, the botnet agent host may select these devices based on the digital scene data and/or the security category. For example, the botnet agent host may select one or more additional or alternative Type-1 device(s) and/or Type-2 device(s) that are in the same security category as the Type-1 device that transmits the digital scene data at block 810 (and/or as the Type-2 device that transmits sensing data at step 808). In some examples, the botnet agent host may select one or more additional or alternative Type-1 device(s) and/or Type-2 device(s) based on their location data indicating locations that may be associated with the Type-1 device and/or the Type-2 device in FIG. 8.

Continuing from the above example, based on the digital scene data indicating the home intrusion event, the botnet agent host may generate additional secure-ware for Type-1 device(s) and/or Type-2 device(s) that are installed on the residential house. These additional secure-ware may cause the Type-1 device(s) and Type-2 device(s) to be activated, so that these devices may provide sensing data (for example, image data) to verify the home intrusion event.

At step 814, the botnet agent host may transmit the additional Type-1 secure-ware(s) and/or the additional Type-2 secure-ware(s) to the Type-1 device. At step 816, the Type-1 device may execute the additional Type-1 secure-ware.

Continuing from the above example, the additional Type-1 secure-ware may cause the Type-1 device to activate the camera element and/or the microphone element of the Type-1 device to capture visual and/or audio data. The visual and/or audio data may be processed to determine whether the home intrusion event continues to occur. In some examples, the additional Type-1 secure-ware may be executed in the same Type-1 device at step 816 as the Type-1 device at step 802.

In some examples, the additional Type-1 secure-ware may be executed in a different Type-1 device at step 816 than the Type-1 device at step 802. As described above, the botnet agent host may select one or more additional or alternative Type-1 device(s). In these examples, the additional Type-1 secure-ware(s) may be transmitted to and executed by the selected Type-1 devices(s).

At step 818, the Type-1 device may transmit the additional Type-2 secure-ware (if available) to the Type-2 device. At step 820, the Type-2 device may execute the additional Type-2 secure-ware.

Continuing from the above example, the additional Type-2 secure-ware may cause the Type-2 device to activate the sensing element(s) connected to the Type-2 device. The Type-2 device may transmit sensing data to the Type-1 device, so that the Type-1 device may determine whether the home intrusion event continues to occur. In some examples, the additional Type-2 secure-ware may be executed in the same Type-2 device at step 820 as the Type-2 device at step 806.

In some examples, the additional Type-2 secure-ware may be executed in a different Type-2 device at step 820 than the Type-2 device at step 806. As described above, the botnet agent host may select one or more additional or alternative Type-2 device(s). In these examples, the additional Type-2 secure-ware(s) may be transmitted to and executed by the selected Type-2 devices(s).

It is noted that the scope of the present disclosure is not limited to the examples illustrated above, and other implementations are included in the present disclosure.

For example, the present disclosure may be implemented in a network computer system. In this example, the secure-ware may be configured to cause the Type-1 device(s) and/or Type-2 device(s) to run audit routines and memory checks on the computing devices in the system to detect presence of malicious code and return digital scene data (such as network logs) to the botnet agent host. In some examples, a network cyber-attack may be detected based on the digital scene data indicating the presence of malicious code in the network computer system.

As another example, the present disclosure may be implemented in an Internet of Things (IoT) system to detect malicious cyber activities. For example, the botnet agent host may maintain one or more of email policies, IP routing table policies, and/or Internet connection usage policies. The email policies may indicate the frequency of sending emails to a certain domain. The IP routing table policies may indicate where data packets may travel in the IoT system. The Internet connection usage policies may indicate the domains that a device in the IoT system may connect. In some examples, one or more Type-1 device(s) and/or Type-2 device(s) may be connected to the devices in the IoT system, and may determine whether there is any violation of these policies. Based on determining that there is a violation, malicious cyber activities may be detected. In some examples, a user may select one or more policies to monitor the corresponding violations via a user interface.

Additional implementations may include, for example, managing the life cycles of devices in the IoT system. In some examples, a botnet agent host may manage life cycles of devices in the IoT system based on the life cycle indicators of secure-ware. For example, the botnet agent host may set the life cycle of an IoT device by setting the life cycle indicator of the secure-ware in a Type-2 device that is connected to the IoT device.

As another example, the botnet agent host may be configured to analyze historical digital scene data of various security categories using machine learning algorithms. For example, the botnet agent host may identify information and infrastructure wastage in a place or premises, and may generate optimization data to optimize the infrastructure and provide cost savings. Additionally, or alternatively, the botnet agent host may identify zones in a place or premises where the infrastructure is underutilized, and may balance the utilization rate. As another example, based on the historical digital scene data, the botnet agent host may generate prediction data indicating the probability of device failure in the system.

As another example, various embodiments of the present disclosure may be implemented to analyze and/or detect a cyber-attack or a cyber-physical attack. A cyber-physical system (CPS) may comprise interacting analog, digital, physical, and/or human components, which may be controlled or monitored by computer-based algorithms and/or integrated with the Internet and its users. In addition to the routine and/or fit-for-purpose secure-ware, the botnet agent may generate additional secure-ware, which may be configured to conduct security auditing and/or compliance checks in Type-1 device(s) and/or Type-2 device(s).

For example, referring back to FIG. 8, the Type-1 secure-ware executed by the Type-1 device at block 802 (and/or the additional Type-1 secure-ware executed by the Type-1 device at block 816) may cause the Type-1 device to conduct security auditing and/or compliance checks. For example, Type-1 device may review application and/or operating system access controls, analyze physical access to the systems, and/or perform security vulnerability scans. Additionally, or alternatively, the Type-2 secure-ware executed by the Type-2 device at block 806 (and/or the additional Type-2 secure-ware executed by the Type-2 device at block 820) may cause the Type-2 device to conduct security auditing and/or compliance checks, including, but is not limited to, reviewing application and/or operating system access controls, analyzing physical access to the systems, and/or performing security vulnerability scans.

Based on the aggregated results received at botnet agent host from the Type-1 device(s) and/or Type-2 device(s), a security incident (such as, but is not limited to, cyber intrusion/exploit) may be identified (if detected). Additionally, or alternatively, additional secure-ware may be sent on detecting exploits in Type-1 device(s) and/or Type-2 device(s) to confirm and/or report a security incident.

Referring now to FIG. 9, an example user interface 900 in accordance with various examples of the present disclosure are illustrated. In particular, a user may operate an example computing device (such as a client device in communication with the botnet agent host 101 described above in connection with FIG. 1) to view and/or interact with example user interface as illustrated in FIG. 9 via a display of the example computing device. It is noted that the scope of the present disclosure is not limited to desktop computer, and other devices may be used in accordance with embodiments of the present disclosure (including, for example, mobile phone, wearable devices) to view and/or interact with the example user interface 900 in accordance with various embodiments of the present disclosure.

The example user interface 900 may comprise a side bar 901. The side bar 901 allows a user to select a security category (such as “red,” “yellow,” or “green”). In the example as shown in FIG. 9, the selected security category is “red,” which is also indicated by the security category label 907. Once the security category is selected, the botnet agent host may cause the display of only scenes that are associated with the selected security category.

Additionally, or alternatively, the example user interface 900 may comprise a video feed portion 905. The video feed portion 905 may display a video feed of an area that is captured by, for example, a camera element of a Type-1 device. The user may identify and place areas captured in the video feed into multiple security categories.

Based on the video feed displayed in the video feed portion 905, the user may request the botnet agent host to generate one or more additional secure-ware for the Type-1 device(s) and Type-2 device(s). For example, when the video feed shows that a child is crawling towards the swimming pool area, the user may request the botnet agent host to generate additional secure-ware to trigger an audio warning message, as described above.

In some examples, the example user interface 900 may enable the user to set contexts in the scenes based on incidents in areas and the security category it belongs. For example, the example user interface 900 may comprise a side bar 903 that may enable context setting. Options for context setting may include a scheduler option and an exception option. The scheduler option may allow the user to set rules for the scene, such as a time period. For example, a child detected in the swimming pool during a time period that he is not allowed in this area may trigger a Type-1 device to generate an audio warning message as described above. The exception option may allow the user to set exceptions for the scene. For example, an adult detected in the swimming pool area may not trigger a Type-1 device to generate an audio warning message.

It is to be understood that the disclosure is not to be limited to the specific embodiments disclosed, and that modifications and other embodiments are intended to be included within the scope of the appended claims. Although specific terms are employed herein, they are used in a generic and descriptive sense only and not for purposes of limitation, unless described otherwise.

1. An apparatus comprising a first processor and a first non-transitory memory comprising program code, wherein the first non-transitory memory and the program code are configured to, with the first processor, cause the apparatus to at least:
receive location data associated with at least one Type-1 device and at least one Type-2 device;
based at least in part on the location data, generate at least one Type-1 secure-ware for the at least one Type-1 device and at least one Type-2 secure-ware for the at least one Type-2 device;
transmit the at least one Type-1 secure-ware and the at least one Type-2 secure-ware to the at least one Type-1 device; and
cause the at least one Type-1 device to execute the at least one Type-1 secure-ware, wherein the at least one Type-1 secure-ware is configured to cause the at least one Type-1 device to transmit the at least one Type-2 secure-ware to the at least one Type-2 device.

2. The apparatus of claim 1, wherein the at least one Type-1 device comprises at least one second processor and at least one second non-transitory memory.

3. The apparatus of claim 2, wherein the at least one Type-1 device comprises at least one of a camera element or a microphone element.

4. The apparatus of claim 2, wherein the at least one Type-1 device comprises a sensor-independent interface, and wherein the sensor-independent interface is configured to electronically couple the at least one Type-1 device to the at least one Type-2 device.

5. The apparatus of claim 1, wherein the at least one Type-1 secure-ware comprises at least one life cycle indicator, and wherein the first non-transitory memory and the program code are configured to, with the first processor, cause the apparatus to further:
cause the at least one Type-1 device to exit the at least one Type-1 secure-ware based on the at least one life cycle indicator.

6. The apparatus of claim 1, wherein the at least one Type-2 device comprises at least one sensor-dependent interface, and wherein the at least one sensor-dependent interface is configured to electronically couple the at least one Type-2 device to at least one sensing element.

7. The apparatus of claim 6, wherein the at least one Type-2 secure-ware comprises at least one software driver for the at least one sensing element.

8. A computer-implemented method, comprising:
receiving location data associated with at least one Type-1 device and at least one Type-2 device;
based at least in part on the location data, generating at least one Type-1 secure-ware for the at least one Type-1 device and at least one Type-2 secure-ware for the at least one Type-2 device;
transmitting the at least one Type-1 secure-ware and the at least one Type-2 secure-ware to the at least one Type-1 device; and
causing the at least one Type-1 device to execute the at least one Type-1 secure-ware, the at least one Type-1 secure-ware configured for causing the at least one Type-1 device to transmit the at least one Type-2 secure-ware to the at least one Type-2 device.

9. The computer-implemented method of claim 8, wherein the at least one Type-1 device comprises at least one second processor and at least one second non-transitory memory.

10. The computer-implemented method of claim 9, wherein the at least one Type-1 device comprises at least one of a camera element or a microphone element.

11. The computer-implemented method of claim 9, wherein the at least one Type-1 device comprises a sensor-independent interface, and wherein the sensor-independent interface is configured to electronically couple the at least one Type-1 device to the at least one Type-2 device.

12. The computer-implemented method of claim 8, wherein the at least one Type-1 secure-ware comprises at least one life cycle indicator, wherein the computer-implemented method further comprises:
causing the at least one Type-1 device to exit the at least one Type-1 secure-ware based on the at least one life cycle indicator.

13. The computer-implemented method of claim 8, wherein the at least one Type-2 device comprises at least one sensor-dependent interface, and wherein the at least one sensor-dependent interface is configured to electronically couple the at least one Type-2 device to at least one sensing element.

14. The computer-implemented method of claim 13, wherein the at least one Type-2 secure-ware comprises at least one software driver for the at least one sensing element.

15. A computer program product comprising at least one non-transitory computer-readable storage medium having computer-readable program code portions stored therein, the computer-readable program code portions comprising an executable portion configured to:
receive location data associated with at least one Type-1 device and at least one Type-2 device;
based at least in part on the location data, generate at least one Type-1 secure-ware for the at least one Type-1 device and at least one Type-2 secure-ware for the at least one Type-2 device;
transmit the at least one Type-1 secure-ware and the at least one Type-2 secure-ware to the at least one Type-1 device; and
cause the at least one Type-1 device to execute the at least one Type-1 secure-ware, wherein the at least one Type-1 secure-ware is configured to cause the at least one Type-1 device to transmit the at least one Type-2 secure-ware to the at least one Type-2 device.

16. The computer program product of claim 15, wherein the at least one Type-1 device comprises at least one second processor and at least one second non-transitory memory.

17. The computer program product of claim 16, wherein the at least one Type-1 device comprises at least one of a camera element or a microphone element.

18. The computer program product of claim 16, wherein the at least one Type-1 device comprises a sensor-independent interface, and wherein the sensor-independent interface is configured to electronically couple the at least one Type-1 device to the at least one Type-2 device.

19. The computer program product of claim 15, wherein the at least one Type-1 secure-ware comprises at least one life cycle indicator, and wherein the executable portion is configured to further:
cause the at least one Type-1 device to exit the at least one Type-1 secure-ware based on the at least one life cycle indicator.

20. The computer program product of claim 15, wherein the at least one Type-2 device comprises at least one sensor-dependent interface, and wherein the at least one sensor-dependent interface is configured to electronically couple the at least one Type-2 device to at least one sensing element.

21. The apparatus of claim 1, the location data comprising:
a first location descriptor describing a first geolocation associated with the at least one Type-1 device, and
a second location descriptor describing a second geolocation associated with the at least one Type-2 device.

22. The apparatus of claim 21, wherein the first non-transitory memory and the program code are configured to, with the first processor, cause the apparatus to further:
generate the at least one Type-1 secure-ware for the at least one Type-1 device based at least in part on the first location descriptor; and
generate the at least one Type-2 secure-ware for the at least one Type-2 device based at least in part on the second location descriptor.
